(19) United States
(12) Patent Application Publication
(10) Pub. No.: US 2006/0023733 A1
(43) Pub. Date: Feb. 2, 2006

(54) Packet transfer apparatus

(76) Inventors: Shinsuke Shimizu, Yokohama (JP); Hiroaki Miyata, Yokohama (JP); Jun Nakajima, Yokohama (JP); Yoshitaka Sakamoto, Yokohama (JP); Migaku Ota, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/028,309

(22) Filed: Jan. 4, 2005

(30) Foreign Application Priority Data
Jul. 30, 2004 (JP) 2004-222735

(51) Int. Cl. H04L 12/56

(52) U.S. Cl. 370/432

(57) ABSTRACT

Upon receiving a connection request from a terminal, a packet transfer apparatus registers information on the terminal with a memory and forwards information necessary for the authentication of the terminal and an authentication request to an authentication server. The apparatus then receives authentication permission and a multicast group address list associated with the terminal that has made the connection request from the server. The apparatus then associates the multicast group address list received with the terminal information stored in the memory for registration. Upon receiving a participation request from the terminal, the apparatus determines whether or not the group address contained in the participation request is present in the list in the memory. If the group address is present in the list in the memory, the apparatus permits the delivery of a packet to the terminal from a content delivery server and transmits the packet to the terminal.

### CLAIM OF PRIORITY

The present application claims priority from Japanese application serial no. 2004-222735, filed on Jul. 30, 2004, the content of which is hereby incorporated by reference into this application.

### BACKGROUND OF THE INVENTION

The present invention relates to a multicast communications technique used for the delivery of information such as content.

Multicast communications technologies are known as communications technologies effective for the simultaneous delivery of information such as the same content to a large number of (user) terminals. Multicast communications has the advantage of applying lower loads to delivery servers and using lower traffic as compared with unicast communications, which involves delivering information to each of a plurality of terminals on a point-to-point communications basis. In multicast communications technologies using the Internet Protocol (IP), the “Internet Group Membership Protocol (IGMP)” is used as a protocol for IPv4 communications and the “Multicast Listener Discovery” protocol for IPv6 communications. The IGMP is defined in open Internet Standards by the Internet Engineering Task Force (IETF)—Chapters 4 and 7, and Appendix 1, RFC1112 (related art 1), and Chapters 2, 3, 6, and 7, RFC2236 (related art 2). Similarly, the MLD protocol is defined in Chapters 3, 4, 5, and 6, RFC2710 (related art 3). The above-mentioned IGM and MLD protocols are used between a terminal and a packet transfer apparatus (such as gateways and routers). These protocols are designed for controlling a group of terminals configured to receive delivered data (a multicast group) in multicast communications where the same data is efficiently delivered to a plurality of hosts. The IGMP or MLD protocol is used when a terminal makes a participation request to a multicast group (request for multicast data delivery) or makes a request for withdrawal from the multicast group (request for stop of multicast data delivery).

On the other hand, participants of the multicast group all-receive information such as the same content. Thus, there are concerns about problems including differences in service levels available to each user, incorrect accesses and accounting. The acquisition information such as content therefore requires a method for authenticating users.

For an authentication method in multicast communications, a method described below is known. In this authentication method, an application for participation from a receiving host is followed by the advance registration of any receiving host that can participate in a multicast group with a user authentication server. An IGMP membership report showing a participation request from the receiving host is then transmitted to a router and an authentication is performed on the receiving host based on information contained in the report and the details of its registration in the above-mentioned user authentication server. After the authentication, the receiving host is permitted to participate in the multicast group during a permitted time. (Related art 4, Japanese Patent Laid-open No. 2003-158547)

In the multicast authentication method described in the related art 4, however, the user authentication server authenticates the host based on the details of the IGMP membership report and that of the registration every time the report is received. Each connection switching to a different group is therefore followed by authentication processing, thus resulting in an increase in switching delay and in processing load on the router and the authentication server.

A multicast authentication method is therefore known for providing simpler and faster processing. This authentication method requires only the first authentication by an authentication server with a user ID and password. The second and subsequent authentication sessions involves the use of a group list table provided in a router. (Related art 5, Japanese Patent Laid-Open Application No. 2003-348149)

### SUMMARY OF THE INVENTION

In the multicast authentication method described in the above-mentioned related art 5, upon receipt of an authentication request, the authentication server checks the user ID and password added to the authentication request with a user's ID and password registered in advance to determine whether to authenticate the user. The authentication server then makes a group list request to a customer data server, which then receives the group list request and transmits to the authentication server a group list response that contains user IDs and group lists.

The multicast authentication method described in the related art 5 involves performing authentication processing by means of two servers, an authentication server and a custom data server, thus resulting in a larger authentication-caused time delay.

In addition, most of the current multicast communications using Internet protocols (IPs) are of the PPP type using IPv4. Because of problems with the depletion of available addresses, it is thought that most future multicast communications will be of the type using IPv6. Thus, an apparatus that accommodate multicast communications of both the above-mentioned PPP and IP types is desired for the smooth transfer to IPv6.

However, the aforementioned related arts 1 to 5 do not describe means that accommodates both PPP and IP multicast communications.

To solve the problems described above, a packet transfer apparatus according to the present invention includes a plurality of line interfaces adapted to receive and transmit the packet from and to the plurality of terminals or the network; and a processing unit for performing necessary processing based on contents of a packet received through any of the plurality of line interfaces before output to any of the plurality of line interfaces; wherein the processing unit performs the steps of: upon receiving a connection request from one of the plurality of terminals, storing information on the terminal in a memory; forwarding information necessary for authenticating the terminal and an authentication request to a authentication server in the network; receiving authentication permission from the authentication server and a group address list associated with the terminal that has made the connection request; associating the multicast group address list received with the information on the terminal stored in the memory for registration; and upon receiving a participation request from one of the plurality of terminals, determining whether or not a multicast group address contained in the participation request is present in the list in the memory, and permitting packet delivery from the network to the terminal if the multicast group address is present in the list in the memory, while rejecting the packet delivery from the network to the terminal if the multicast group address is not present in the list in the memory.

In addition, upon receiving a packet from any of the plurality of terminals, a packet transfer apparatus according to the present invention identifies whether a multicast type of the packet received is a PPP multicast type or an IP multicast type from the packet and performs authentication processing and the like in response to individual multicast types, thereby allowing both the PPP multicast communications and IP multicast communications.

According to the present invention, a simple communications system configuration reduces time delay due to authentication in multicast communications, thereby allowing fast packet communications.

According to the present invention, both the PPP multicast communications and IP multicast communications can be accommodated. This allows a smooth transition from IPv4 to IPv6.

According to the present invention, the invention also eliminates the need for additional functions to users' terminals and new settings, thus resulting in no loads on users and the provision of higher levels of services.

### BRIEF DESCRIPTION OF THE DRAWINGS

Preferred embodiments of the present invention will now be described in conjunction with the accompanying drawings, in which;

FIG. 1 shows the entire configuration of a communications system 200 according to a first embodiment of the present invention;

FIG. 2 shows a header 20 for an IGMP message;

FIG. 3 is a block diagram showing the configuration of a packet transfer apparatus 2;

FIG. 4 is a block diagram showing the detailed configuration of a protocol-processing unit 31 according to the first embodiment of the present invention;

FIG. 5 shows the configuration of a user administration table 47-1 according to the first embodiment of the present invention;

FIG. 6 is a block diagram showing the configuration of an authentication server 4;

FIG. 7 is a sequence diagram showing the operation of the communications system 200 according to the first embodiment of the present invention;

FIG. 8 is another sequence diagram showing the operation of the communications system 200 according to the first embodiment of the present invention;

FIG. 9 shows the configuration of the user administration table 47-1 according to the first embodiment of the present invention (group address deletion);

FIG. 10 shows a display screen of a terminal 1;

FIG. 11 shows another display screen of the terminal 1;

FIG. 12 shows the entire configuration of a communications system 120 according to a second embodiment of the present invention;

FIG. 13 shows the configuration of a header 130 of an MLD message concerning the IPv6;

FIG. 14 is a block diagram showing the configuration of a protocol-processing unit 31 provided for a packet transfer apparatus 2 according to the second embodiment of the present invention;

FIG. 15 shows the configuration of a user administration table 47-1 provided for the protocol-processing unit 31 according to the second embodiment of the present invention;

FIG. 16 is a sequence diagram showing the operation of a communications system 120 according to the second embodiment of the present invention for the viewing of a contracted program in PPP multicast communications;

FIG. 17 is a sequence diagram showing the operation of the communications system 120 according to the second embodiment of the present invention for the viewing of a non-contracted program in PPP multicast communications (additional registration);

FIG. 18 is a sequence diagram showing the operation of the communications system 120 according to the second embodiment of the present invention for the viewing of a contracted program in IP multicast communications;

FIG. 19 is a sequence diagram showing the operation of the communications system 120 according to the second embodiment of the present invention for the viewing of a non-contracted program in IP multicast communications;

FIG. 20 is a sequence diagram showing the operation of the communications system 120 according to the second embodiment of the present invention for authentication rejection in IP multicast communications;

FIG. 21 is a sequence diagram showing the operation of the communications system 120 according to the second embodiment of the present invention for authentication permission in IP multicast communications;

FIG. 22 is a sequence diagram showing the operation of the communications system 120 according to the second embodiment of the present invention for the new registration of user information and a program viewed in IP multicast communications;

FIG. 23 shows a display screen of a terminal 121;

FIG. 24 shows another display screen of the terminal 121;

FIG. 25 shows another display screen of the terminal 121;

FIG. 26 shows another display screen of the terminal 121;

FIG. 27 shows another display screen of the terminal 121;

FIG. 28 is a flow chart showing processing by a processor 42 provided for the protocol processing unit 31 of the packet transfer apparatus 2 according to the second embodiment of the present invention;

FIG. 29 is another flow chart showing processing by a processor 42 provided for the protocol processing unit 31 of the packet transfer apparatus 2 according to the second embodiment of the present invention;

FIG. 30 is another flow chart showing processing by a processor 42 provided for the protocol processing unit 31 of the packet transfer apparatus 2 according to the second embodiment of the present invention; and

FIG. 31 is another flow chart showing processing by a processor 42 provided for the protocol-processing unit 31 of the packet transfer apparatus 2 according to the second embodiment of the present invention.

### DESCRIPTION OF THE PREFERRED EMBODIMENTS

A first embodiment of the present invention will be first described.

FIG. 1 shows the entire configuration of a communications system 200 in which a packet transfer apparatus according to the present invention is used. It is to be noted that the first embodiment will be described in terms of multicast communications using the IGMP.

A communications system 200 includes a plurality of terminals 1, a packet transfer apparatus (e.g., an access server) 2 connected to these terminals, a network (e.g., an Ipv4 network) 5 connected to the packet transfer apparatus 2, and a content delivery server 3 and an authentication server 4 which are connected to the network 5.

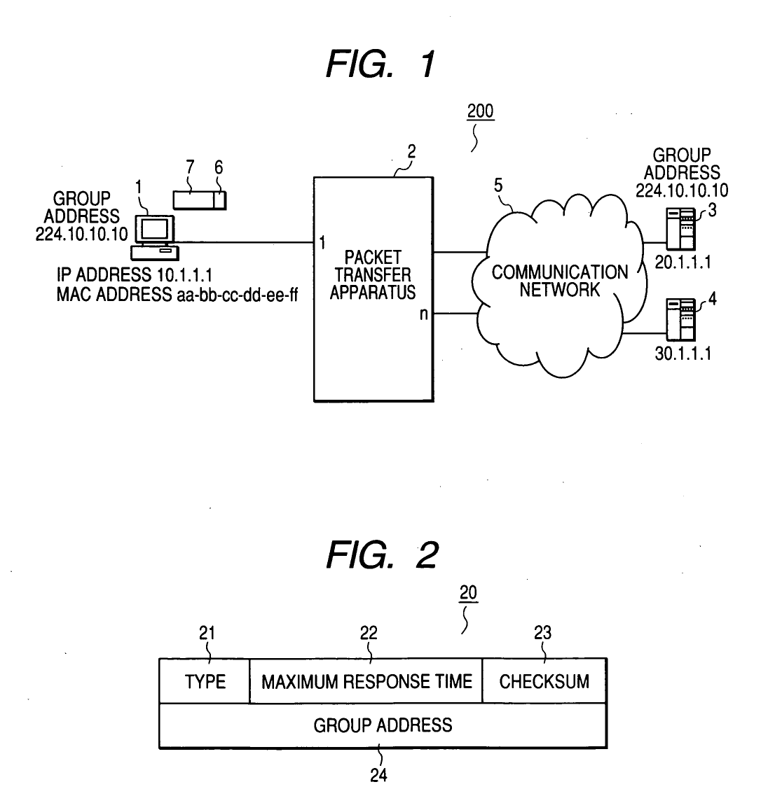

Terminal users have already entered into a contract with a content delivery company for programs available to these users, each of which is associated with multicast group addresses. Each terminal is provided with an MAC address and an IP address for identifying a group address and a terminal. The content delivery server 3 is also provided with a group address and an IP address. In FIG. 1, characters 1 and n, given to the packet transfer apparatus, refer to port numbers. In the communications system according to the first embodiment, an IGMP message, shown in FIG. 2, is also received and transmitted in a form of a packet 7 having a header 6.

The content delivery server 3 delivers the content of a program that the user of a terminal 1 has made a request for to the terminal 1 provided with the same group address (224.10.10.10). The authentication server 4 associates information necessary for terminal authentication (e.g., an user ID and a password) with a group address list for programs about which each terminal user has entered into a contract with a content delivery company in advance for administration purposes (hereinafter referred to as a “group list”). In the first embodiment, upon receiving a connection request from the terminal 1 the packet transfer apparatus 2 registers information on the terminal 1 in a memory and forwards information necessary for authenticating the terminal (a user ID and a password) and an authentication request to the authentication server 4. The packet transfer apparatus receives authentication permission and a multicast group address list received associated with the terminal that have made the connection request from the authentication server 4. The packet transfer apparatus then associates the multicast group address list with the terminal information stored in the memory for registration purposes. When receiving a participation request from the terminal 1, the packet transfer apparatus determines whether the multicast group address contained in the participation request is present in a list in the memory. When the multicast group address is present in a list in the memory, the packet transfer apparatus permits the delivery of a packet from the content delivery server 3 to the terminal 1 and transmits the packet to the terminal 1. The foregoing will be further detailed later.

FIG. 2 shows the configuration of a header 20 for an IGMP message. As described in RFC1112 and RFC2236, the header 20 for the IGMP message has fields for a type 21, a maximum response time 22, a checksum 23, and a group address 24. Whether a request from a terminal is for participation or withdrawal can be identified by means of the type 21. In addition, a multicast group address for the IPv4 will be entered in the group address 24.

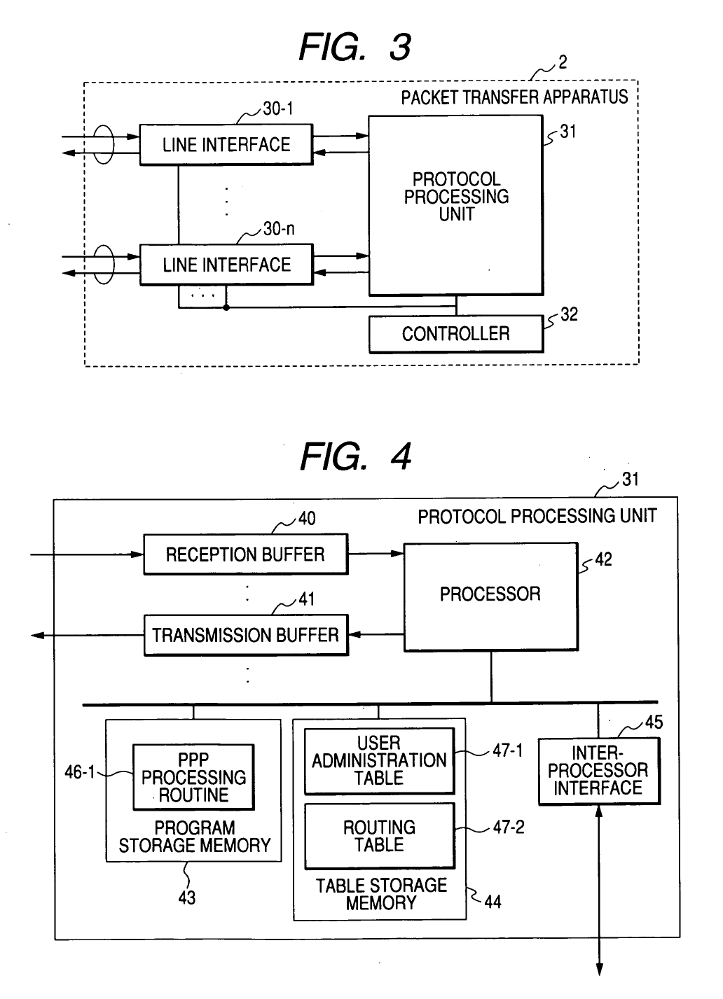

FIG. 3 is a block diagram showing the configuration of the packet transfer apparatus 2 according to the first embodiment. The packet transfer apparatus 2 includes a plurality of line interfaces 30-1, . . . , 30-n, a protocol processing unit 31, and a control unit 32 that controls these in an overall manner.

Line interfaces 30-1, . . . , 30-n, i.e., interfaces with a plurality of terminals and a network 5, are adapted to receive and transmit packets (e.g., PPP packets) from and to the plurality of terminals and the network 5. The protocol-processing unit 31 performs protocol processing and routing processing for received packets based on the content of the packet received through any of the plurality of line interfaces for output to any of the plurality of line interfaces.

FIG. 4 is a block diagram showing the detailed configuration of the protocol-processing unit 31. The protocol processing unit 31 includes: a plurality of reception buffers 40 for temporarily storing a packet from a line interface; a processor 42 for reading a packet out of the reception buffer and performing protocol processing; a program storage memory (memory) 43 for storing a program (PPP processing routine) 46-1 to be executed by the processor 42; a table storage memory (memory) 44 for storing various tables (a user administration table 47-1 and a routing table 47-2); a plurality of transmission buffers 41 for temporarily storing a packet to a line interface; and an inter-processor interface 45 that is an interface with the control unit 32. The processor 42 reads out and changes a packet stored temporarily in any reception buffer to a message. The processor then performs processing necessary for protocol processing by using the PPP processing routine 46-2 and the user administration table 47-1 and assembles the message back into a packet before output to any transmission buffer 41 according to the routing table.

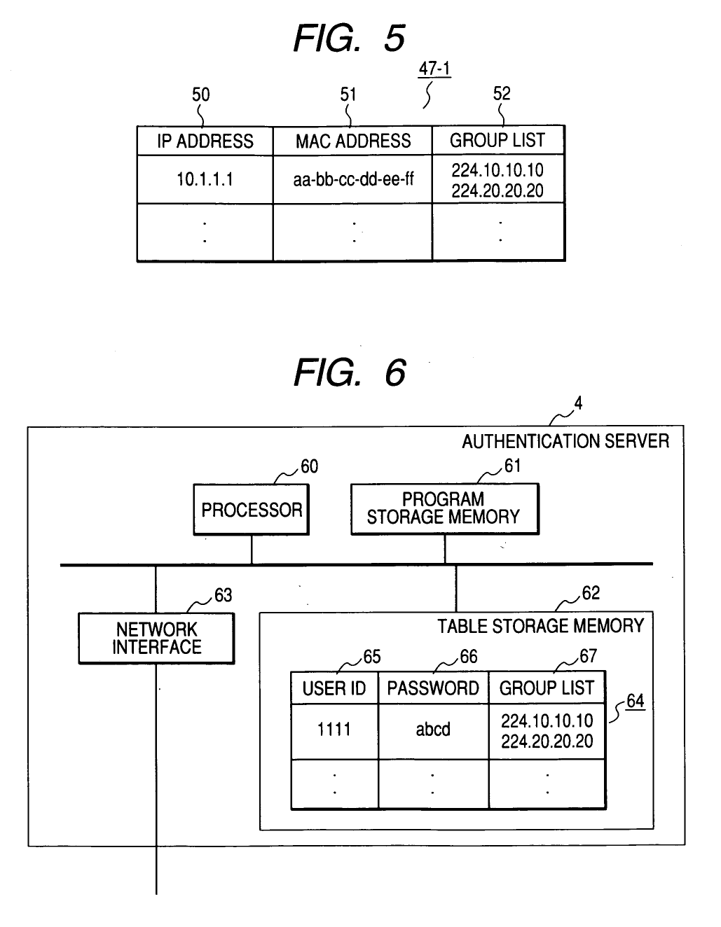

FIG. 5 shows the configuration of a user to administration table 47-1. The user administration table 47-1 stores terminal information (an IP address 50 and an MA address 51 given to a terminal, in the first embodiment) and a group list 52 to be received from an authentication server 4 in an associative manner.

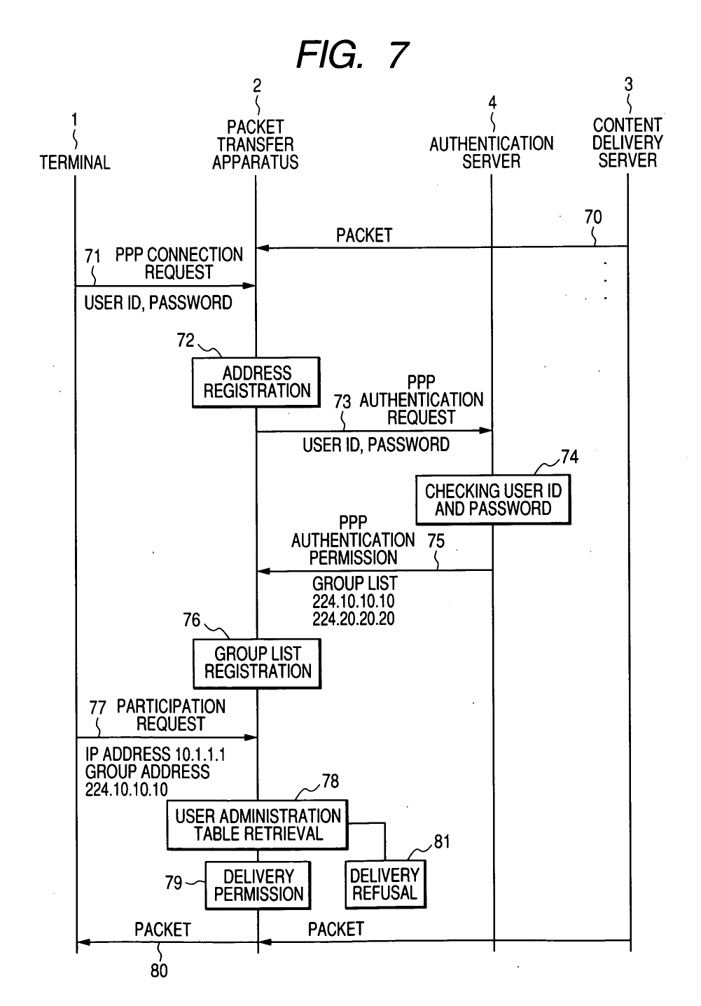

FIG. 6 is a block diagram showing the configuration of an authentication server 4. The authentication server 4 includes a processor 60, a program storage memory 61 for storing a program to be executed by the processor, a table storage memory 62 for storing a group list administration table 64, and a net interface 63 that is an interface with a network 5. The group list administration table 64 registers therein a group list 67 and information on a user ID 65 and a password-66 for each terminal in an associative manner. Incidentally, for group registration, a user may select a desired program from the screen of a terminal 1 in a program contract list, for example. In this case, information on the program is then transmitted as a group list from the terminal 1 and written into the group list administration table 64 in the authentication server 4 via the packet transfer apparatus 2 and the network 5.

The operation of the first embodiment will be described in detail below.

FIG. 7 is a sequence diagram showing the operation of the communications system 200 according to the first embodiment of the present invention. A content delivery server 3 has transmitted a multicast packet to a packet transfer apparatus 2 (Step 70). At the time, however, a packet has not been transmitted to a terminal 1 from the content delivery server 3.

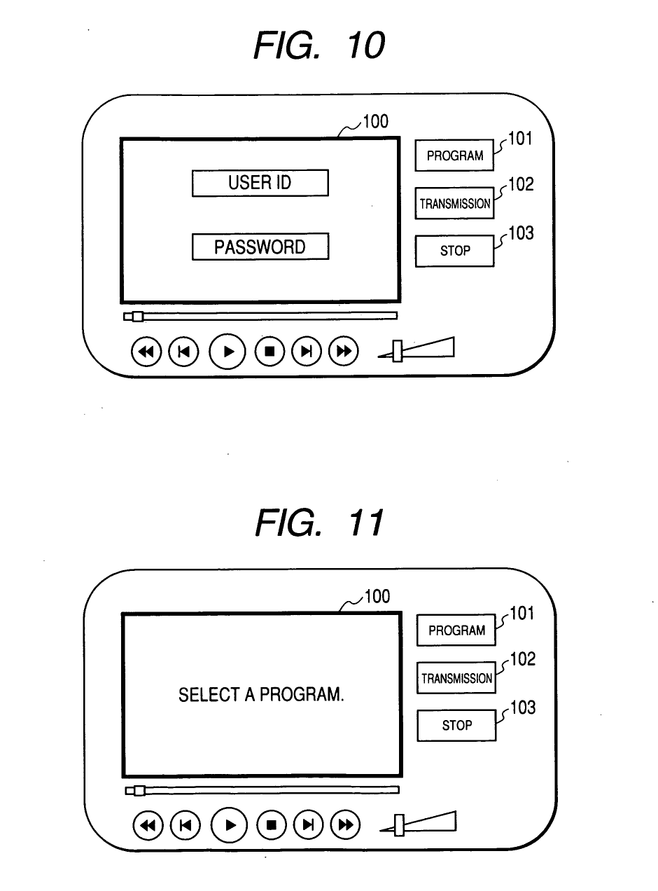

When, for example, a user inputs a user ID and a password from a software screen 100 (e.g., a media player) pre-installed in the terminal 1 as shown in FIG. 10 and presses a transmission button 102, a PPP connection request is transmitted to a packet transfer apparatus 2 (Step 71).

When receiving the PPP connection request from the terminal 1, for example, via the line interface 30-1 and the reception buffer 40 (Step 71), the processor 42 of the protocol-processing unit 31 provided for the packet transfer apparatus 2 registers an IP address (10. 1. 1. 1) and an MAC address (aa-bb-cc-dd-ee-ff) for the terminal 1, which are attached to the request, with the user administration table 47-1 (Step 72). The processor 42 then makes a PPP authentication request including a user ID and a password to a server 4. Note that the PPP authentication request is transmitted to the authentication server 4 via any transmission buffer 41 and a line interface 30.

When receiving the PPP authentication request from the packet transfer apparatus 2, the authentication server 4 checks the user ID and password contained in the PPP authentication request with registration information in the group list administration table 64 (Step 74). If the user ID and password have been already registered with the group list administration table 64, the authentication server 4 transmits a packet including information showing PPP authentication permission and the group list for the terminal 1 to the packet transfer apparatus 2 (Step 75).

The processor 42 of the protocol-processing unit 31 provided for the packet transfer apparatus 2 then registers the group list from the authentication server 4 with the user administration table 47-1 (Step 76).

When the user of the terminal 1 selects a desired program 101 (group address: 224. 10. 10. 10) from the terminal 1 and presses the transmission button 102, a participation request is transmitted to the packet transfer apparatus 2 (Step 77).

Upon receiving the participation request, the processor 42 of the protocol-processing unit 31 provided for the packet transfer apparatus 2 retrieves the user administration table 47-1 based on the IP address and the MAC address (Step 78). If there is a group address contained the participation request in the table with respect to a matching IP address and MAC address, the apparatus permits the delivery of a multicast packet from the content delivery server 3 (Step 79). The packet transfer apparatus 2 then transmits a multicast packet from the content delivery server 3 to the terminal 1 (Step 80).

If such a group address is not in the table as a result of the retrieval at Step 78, the packet transfer apparatus 2 rejects the delivery of a multicast packet to the terminal 1 (Step 81).

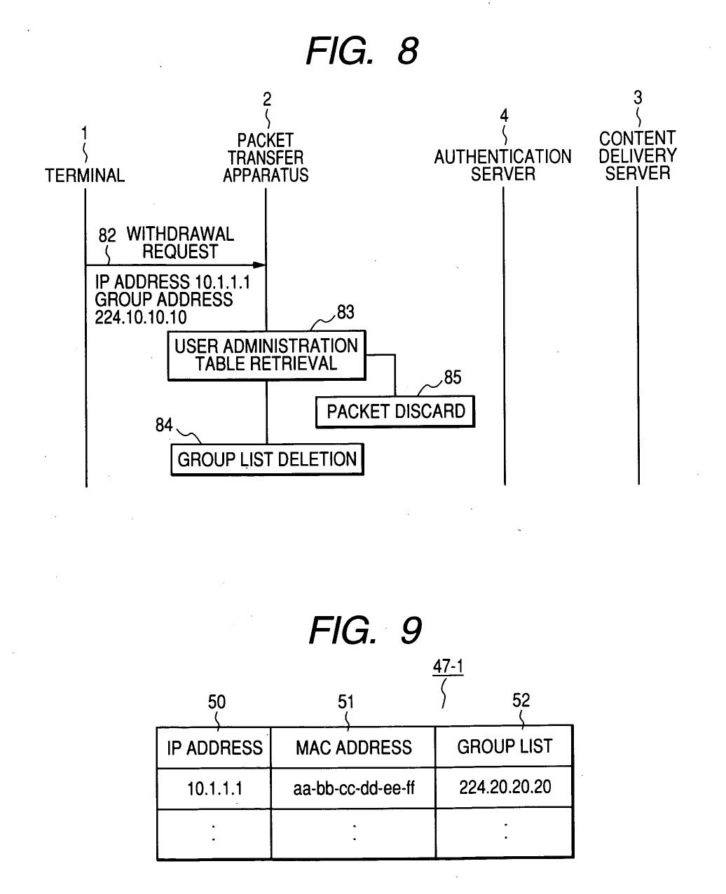

FIG. 8 is another sequence diagram showing the operation of the communications-system 200 according to the first embodiment. When, for example, receiving a withdrawal request for a contracted program (group address: 224. 10. 10. 10) from the terminal 1 (Step 82), a packet transfer apparatus 2 retrieves the user administration table 47-1 based on an IP address and MAC address (Step 83). If there is a group address (224. 10. 10. 10. 10) contained in the withdrawal request in the table with respect to a matching IP address and MAC address, the packet transfer apparatus 2 deletes the group address (224. 10. 10. 10. 10) from a user administration table 47-1 (Step 84, FIG. 9).

If the group address is not in the table as a result of the retrieval at Step 82, the packet transfer apparatus 2 discards the multicast packet from the content delivery server 3 (Step 85).

According to the first embodiment, as described above, the authentication server 4 performs PPP authentication and transmits a group address list administrated to the packet transfer apparatus 2. The packet transfer apparatus 2 associates the list with terminal information and registers the list with the table. When receiving a request for participation in any multicast group contained in the list from the terminal, the packet transfer apparatus 2 transmits a multicast from the content delivery server to the terminal that has made the participation request, based on the participation request and the contents of the table. Accordingly, the system configuration thus simplified reduces time delay due to authentication in multicast communications, thereby allowing fast communications.

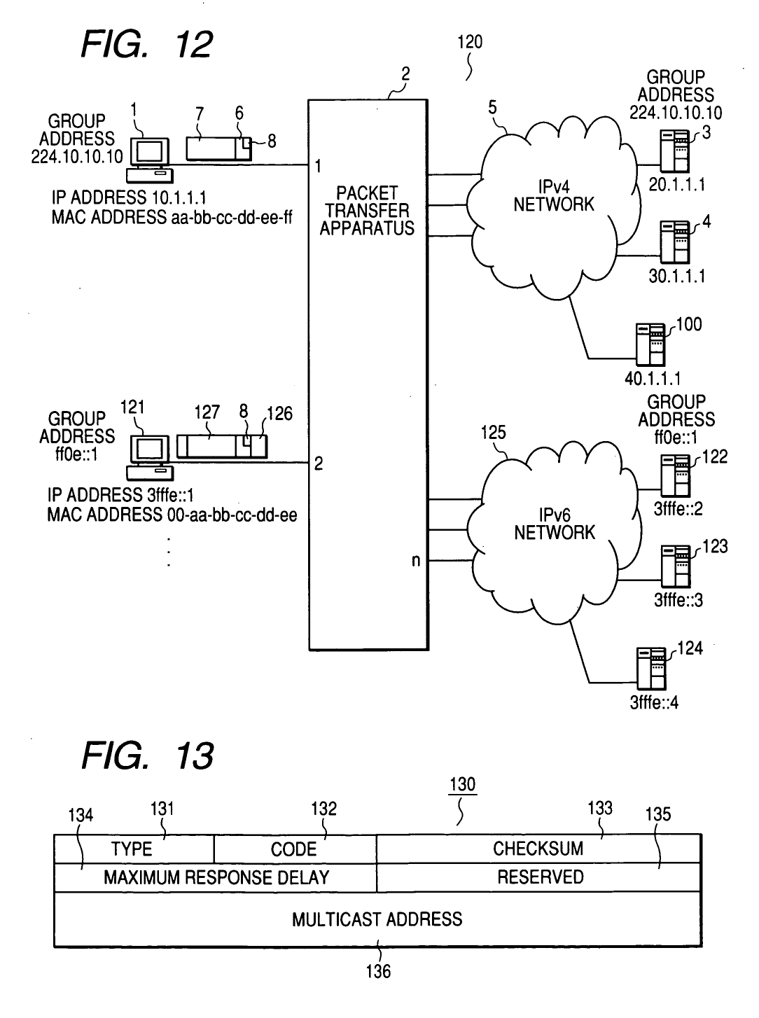

A second embodiment of the present invention will now be described below. FIG. 12 shows the entire configuration of a communications system 120 using a packet transfer apparatus according to the present embodiment. Note that the same components as used in FIG. 1 are given the same reference numerals in FIG. 12. The communications system according to the present embodiment includes a network configuration using the IPv6 in addition to the network configuration using the IPv4 shown in FIG. 1. In the second embodiment, web servers 100 and 124 are connected to the IPv4 network 5 and the IPv6 network 125, respectively. These web servers are provided to notify the WWW browser of a terminal of necessary information (comments) according to a request from the packet transfer apparatus 2.

A packet transmitted from a terminal 1 is an IPv4 packet 7 while a packet transmitted from a terminal 121 is a PPP packet 127 (reference numeral 126 denotes a PPP header), which is an encapsulated IPv6 packet. A packet transfer apparatus 2 determines whether the packet is intended for PPP multicast communications or IP multicast communications through the present or absence of a PPP header in a packet from a terminal. The packet transfer apparatus 2 determines the protocol (the IPv4 or IPv6) through a “version number” 8 provided for the header of an Ipv4 packet or an IPv6 packet contained in a PPP packet.

FIG. 13 shows the configuration of a header 130 of an MLD message concerning the IPv6. As described in RFC 2710, the header of the MLD message has fields such as Type 131, Code 132, Checksum 133, Maximum Response Delay 134, Reserved 135, and Multicast Address 136. A participation request and a withdrawal request from a terminal are identified through the Type field 131. In addition, the Multicast Address field 136 contains a multicast group address for the IPv6.

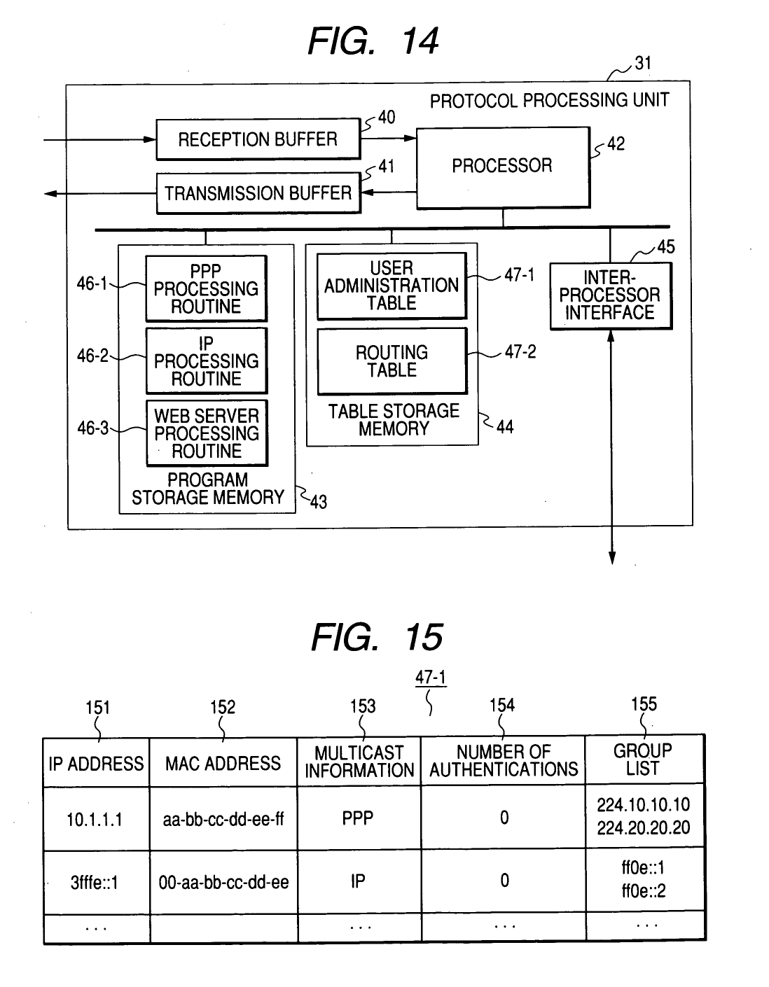

FIG. 14 is a block diagram showing the configuration of the protocol-processing unit 31 provided for the packet transfer apparatus 2 according to the second embodiment. Note that the configuration of the packet transfer apparatus 2 is the same as in FIG. 3. The protocol-processing unit 31 of the second embodiment has the same-configuration as that of the first embodiment except the fact that an IP processing routine 46-2 and a web server processing routine 46-3 are housed in a program storage memory 43 and the configuration of the user administration table 47-1.

FIG. 15 shows the configuration of the user administration table 47-1 provided for the protocol-processing unit 31 according to the second embodiment. The user administration table 47-1 according to the second embodiment stores terminal information (an IP address 151 and an MAC address 152 attached to a terminal in the second embodiment), multicast information 153 representing the type of multicast communications (PPP or IP), the number 154 of authentications, and a group list 155 received from an authentication server 4 or 123, in an associative manner. The number 157 of authentication is counted by a packet transfer apparatus 2 at the time of an authentication request to an authentication server 123 in IP multicast communications. The number of authentications is used to request the web server to notify a terminal of a screen showing that an authentication is unsuccessful when the second authentication is made.

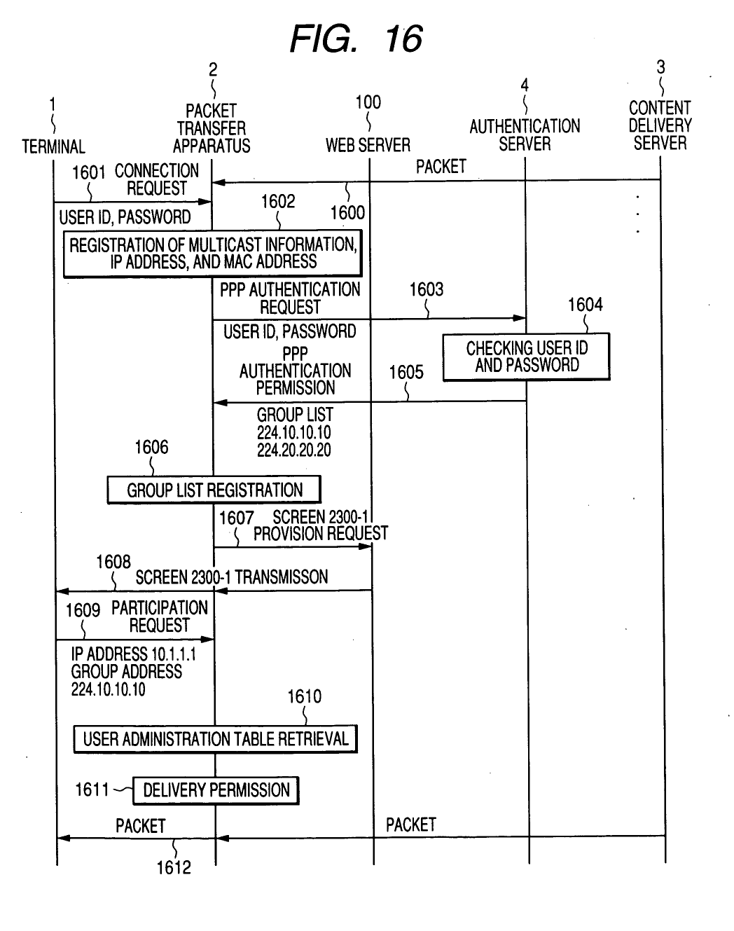

FIGS. 16 to 22 show sequence diagrams each showing the operation of the communications system according to the present invention.

FIG. 16 is a sequence diagram showing the operation of a communications system 120 for the viewing of a contracted program in PPP multicast communications. Note that a multicast packet has already been transmitted to a packet transfer apparatus 2 from a content delivery server 3 (Step 1600), at which time the packet is not delivered to a terminal 1.

When receiving a connection request from a terminal 1 (Step 1601), a processor 42 in a protocol processing unit 31 provided for a packet transfer apparatus 2 identifies PPP multicast communications through a packet and registers information that the communications is of the PPP multicast type and an IP address and a MAC address for the terminal 1 with a user administration table 47-1 (Step 1602). The packet transfer apparatus 2 also identifies the IPv4 through a “version number” 8 (FIG. 12) provided for the header of the packet. The processor 42 then makes a PPP authentication request including an user ID and a password to a authentication server 4 (Step 1603).

A processor 60 in the authentication server 4 checks the user ID and the password for the terminal 1 received via a network interface 63 with an user ID and a password registered with a group list administration table 64 (Step 1604). If there are a relevant user ID and a relevant password in the table, the processor transmits a authentication permission and a group list (224. 10. 10. 10, 224. 20. 20. 20) to the packet transfer apparatus 2 (Step 1605).

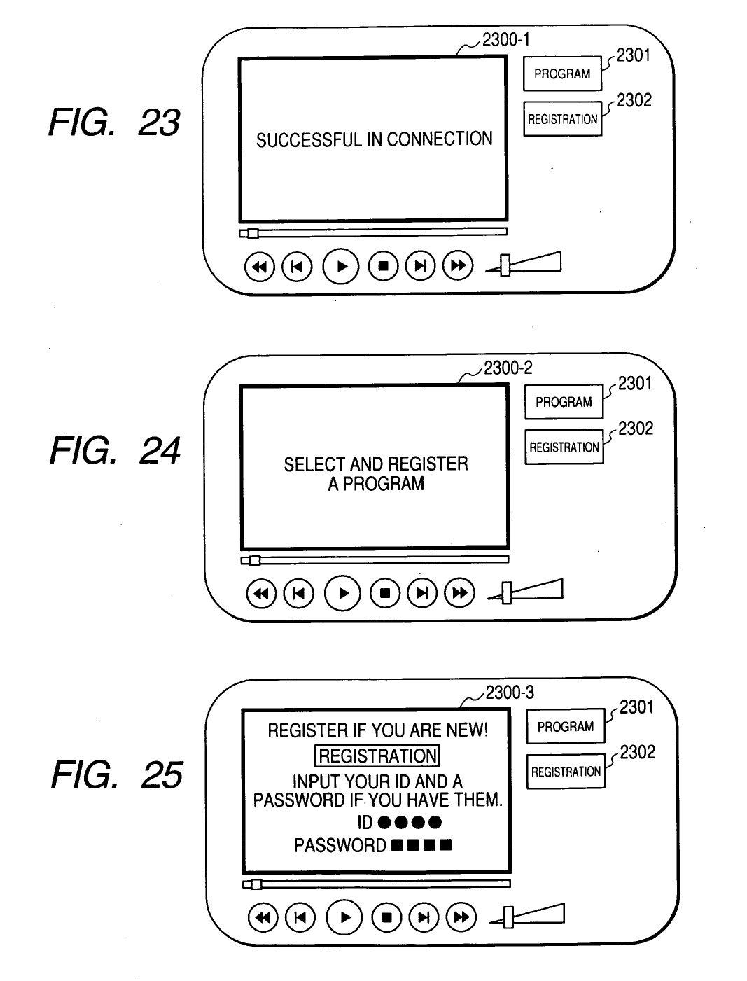

The processor 42 in the protocol processing unit 31 provided for the packet transfer apparatus 2 associates the group list from the authentication server 4 with information (an IP address, an MAC address, and the like) about the terminal 1 before registration with the user administration table 47-1 (Step 1606). The processor 42 then makes to a web server 100 a request for the provision to the terminal 1 of a screen 2300-1 (“Successful in connection”) shown in FIG. 23 (Step 1607).

Upon receiving the above-mentioned provision request from the packet transfer apparatus 2, the web server 100 transmits the screen 2300-1 to the terminal 1 (Step 1608). This allows the screen 2300-1 to be displayed on the WWW browser of the terminal 1.

When, then, the user of the terminal 1 selects a desired program (a group address: 224. 10. 10. 10) from a contracted program 2301 and presses a registration button (or transmission button) 2302, a participation request is transmitted from the terminal 1 to the packet transfer apparatus 2 (Step 1609).

The processor 42 in the protocol-processing unit 31 provided for the packet transfer apparatus 2 retrieves the user administration table 47-1 based on the IP address (10 1. 1. 1), and the MAC address (aa-bb-cc-dd-ee-ff) contained in a packet received (Step 1610). If a group address (224. 10. 10. 10) contained in the participation request is present in the group list, the packet transfer apparatus 2 permits the delivery of a multicast packet from the content delivery server 3 (Step 1611) and transmits the multicast packet to the terminal 1 (Step 1612).

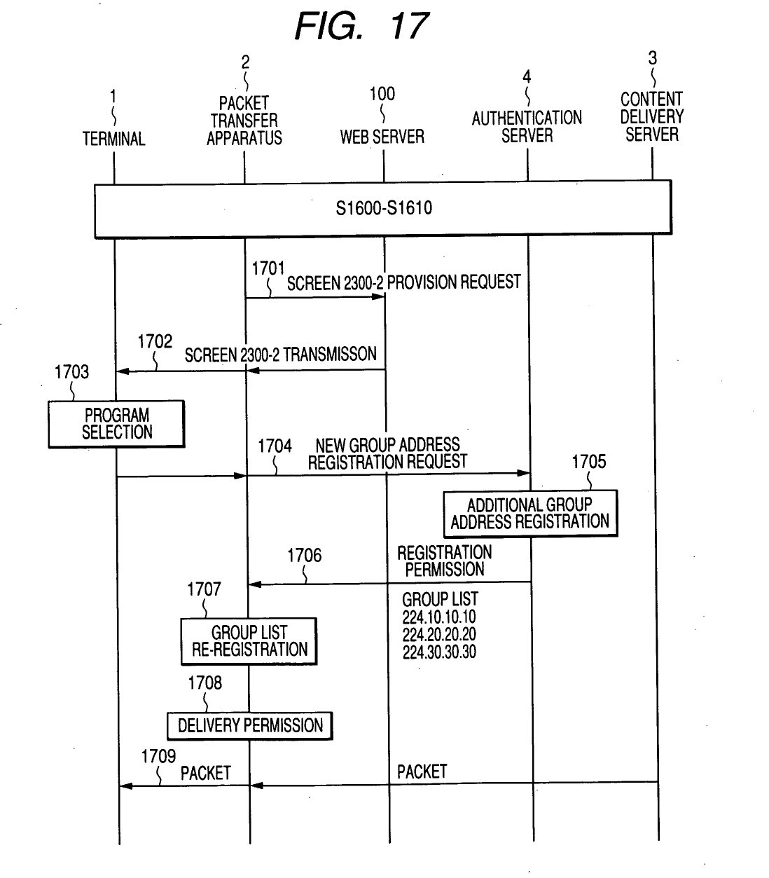

FIG. 17 is a sequence diagram showing the operation of the communications system 120 for the viewing of a non-contracted program in PPP multicast communications (additional registration).

In FIG. 17, the sequence from Steps 1600 to 1610 is the same as in FIG. 16. However, it is now assumed that a non-contracted program (group address: 224. 30. 30. 30, for example) has been selected from a program 2301. In this case, at Step 1610, the processor 42 makes to the web server 3 a request for the provision to the terminal 1 of a screen 2300-2 (“Select and register a program”) shown in FIG. 24 if a group address (224. 30. 30. 30) contained in the participation request is not present in a group list (Step 1701).

Upon receiving the above-mentioned provision request from a packet transfer apparatus 2, the web server 100 transmits the screen 2300-2 to the terminal 1 through the packet transfer apparatus 2 (Step 1702). This allows the screen 2300-2 to be displayed on the WWW browser of the terminal 1.

When, then, the user of the terminal 1 selects a program (a group address: 224. 30. 30. 30) for which the participation request has been made from the program 2301 and presses the registration button 2302 (Step 1703), a request for new registration of the group address (224. 30. 30. 30) is transmitted from the terminal 1 to the authentication server 4 through the packet transfer apparatus 2 (Step 1704).

A processor 60 in the authentication server 4 adds and registers the received group address (224. 30. 30. 30) with the group list for the terminal 1 in a group list administration table 64 (Step 1705). The processor 60 also transmits registration permission and an updated group list (224. 10. 10. 10, 224. 20. 20. 20, and 224. 30. 30. 30) to the packet transfer apparatus 2 (Step 1706).

The processor 42 in the protocol-processing unit 31 provided for the packet transfer apparatus re-registers the group list of the updated terminal 1 with a user administration table 47-1 (Step 1707). The processor 42 also permits the delivery of a multicast packet delivery from a content delivery server 3 (Step 1708) and transmits the multicast packet to the terminal 1 (Step 1709).

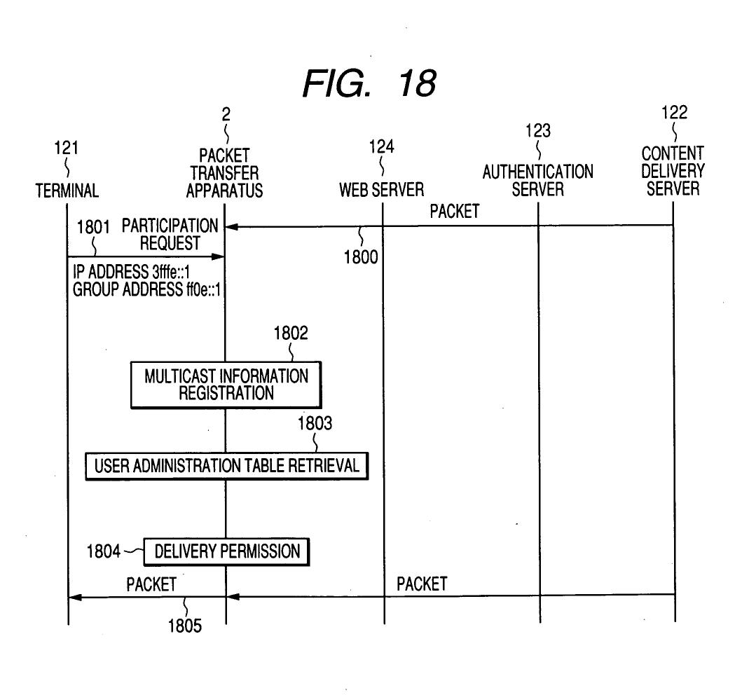

FIG. 18 is a sequence diagram showing the operation of the communications system 120 for the viewing of a contracted program in IP multicast communications. Note that a multicast packet has already been transmitted to a packet transfer apparatus 2 from a content delivery server 122 (Step 1800), at which time the packet is not delivered to a terminal 121.

Upon receiving a participation request (group address: ff0e::1) from the terminal 121 (Step 1801), a processor 42 in a protocol processing unit 31 provided for the packet transfer apparatus 2 identifies IP multicast communications from a packet containing the request and registers the information with a user administration table 47-1 (Step 1802). IP multicast communications involves transmitting a PPP packet and can be identified through the PPP header of the PPP packet. In addition, the processor 42 identifies the IPv6 through a “version number” 8 (FIG. 12) provided for the header of an IPv6 packet contained in the PPP packet. The processor 42 then retrieves the user administration table 47-1 based on the IP address (3ffe::1) contained in the participation request. If the IP address is present in the table, the processor retrieves the user administration table 47-1 based on the group address (ff0e::1) (Step 1803). If the group address is already registered with the user administration table 47-1, the processor 42 permits the delivery of a multicast packet from the content delivery server 122 (Step 1804) and transmits the multicast packet to the terminal 121 (Step 1805).

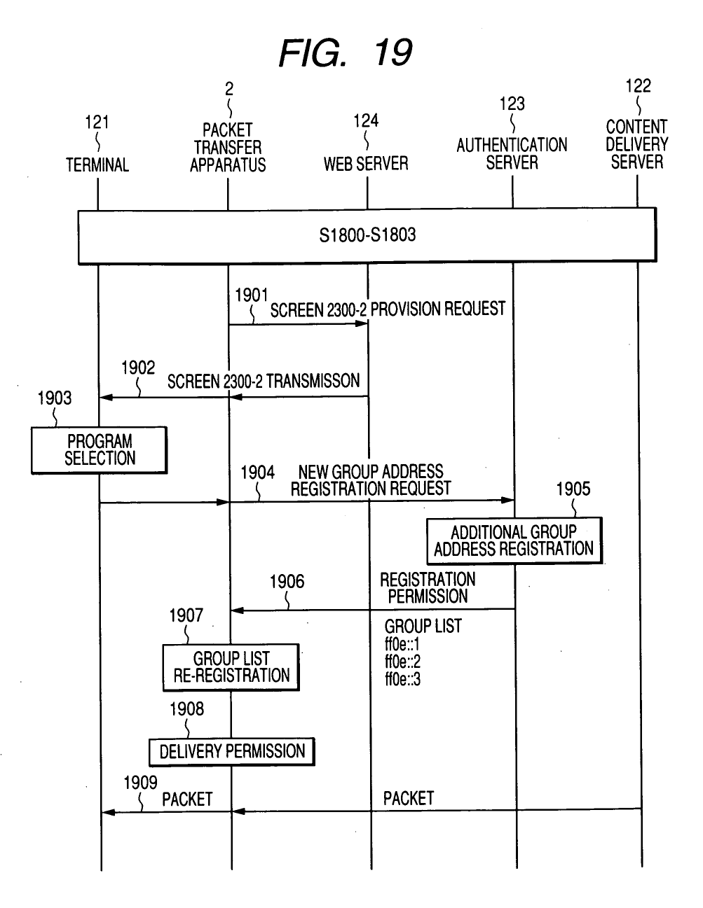

FIG. 19 is a sequence diagram showing the operation of the communications system 120 for the viewing of a non-contracted program in IP multicast communications (additional registration).

In FIG. 19, the sequence from Steps 1800 to 1803 is the same as in FIG. 18. However, it is now assumed that a non-contracted program (group address: ff0e::3, for example) has been selected from a program 2301. In this case, at Step 1804, a processor 42 makes to a web server 124 a request for the provision to a terminal 121 of a screen 2300-2 (“Select and register a program”) shown in FIG. 24 if a group address (ff0e::3) contained in the participation request is not present in a group list (Step 1901).

Upon receiving the above-mentioned provision request from a packet transfer apparatus 2, the web server 124 transmits the screen 2300-2 to the terminal 121 (Step 1902). This allows the screen 2300-2 to be displayed on the WWW browser of the terminal 121.

When, then, the user of the terminal 121 selects a program (a group address: ff0e::3) for which the participation request has been made from the program 2301 (Step 1903), a request for new registration of the group address (ff0e::3) is transmitted from the terminal 121 to an authentication server 123 through the packet transfer apparatus 2 (Step 1904).

The authentication server 123 adds and registers the received group address (ff0e::3) with the group list for the terminal 121 in a group list administration table 64 (Step 1905). The authentication server 123 also transmits registration permission and an updated group list (ff0e::1, ff0e::1, ff0e::1) to the packet transfer apparatus 2 (Step 1906).

A processor 42 in a protocol-processing unit 31 provided for the packet transfer apparatus re-registers the updated group list of the terminal 121 with a user administration table 47-1 (Step 1907). The processor 42 also permits the delivery of a multicast packet from a content delivery server 3 (Step 1908) and transmits the multicast packet to the terminal 121 (Step 1909).

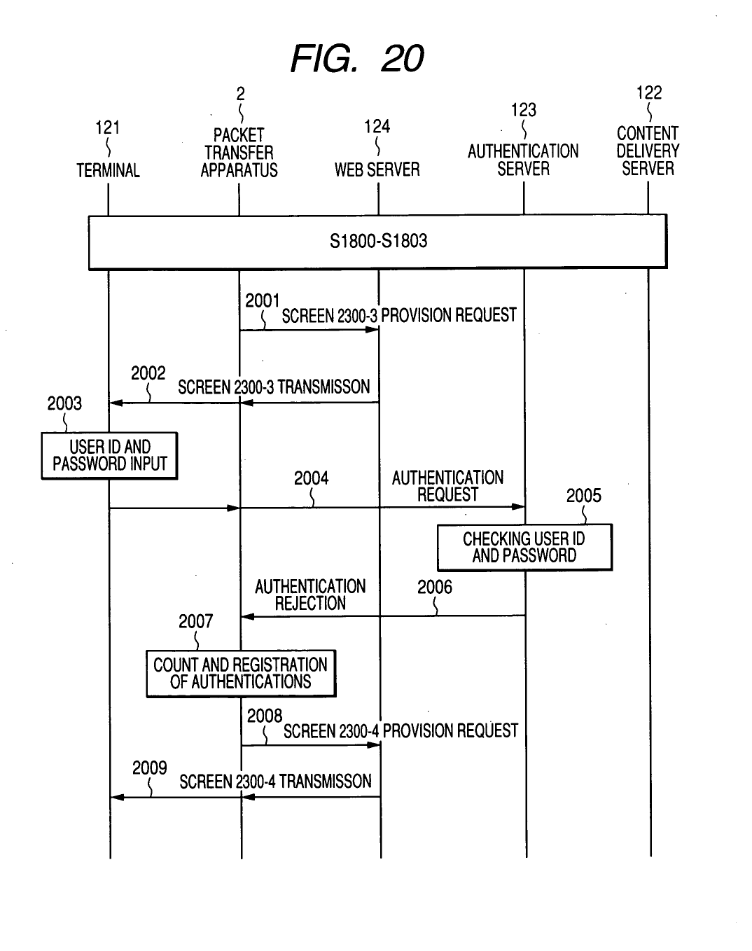

FIG. 20 is a sequence diagram showing the operation of the communications system 120 for authentication rejection in IP multicast communications.

In FIG. 20, the sequence from Steps 1800 to 1803 is the same as in FIG. 18. However, now at Step 1804, the packet transfer apparatus 2 makes to the web server 124 a request for the provision to the terminal 121 of a screen 2300-3 (“Register if you are new. Input your ID and a password if you have them.”) shown in FIG. 25 if there is not an IP address for a terminal 121 (Step 2001).

Upon receiving the above-mentioned provision request from the packet transfer apparatus 2, the web server 124 transmits the screen 2300-3 to the terminal 121 (Step 2002). This allows the screen 2300-3 to be displayed on the WWW browser of the terminal 121.

When, then, the user of the terminal 121 inputs a user ID and a password from the terminal 121 and presses a registration button 2302 (Step 2003), an authentication request is transmitted to an authentication server 123 via the packet transfer apparatus 2 (Step 2004).

The authentication server 123 checks the user ID and the password for the terminal 121 with a user ID and a password registered with a group list administration table (Step 2005). If there are not relevant user ID and relevant password in the table, the authentication server 123 transmits authentication rejection to the packet transfer apparatus 2 (Step 2006).

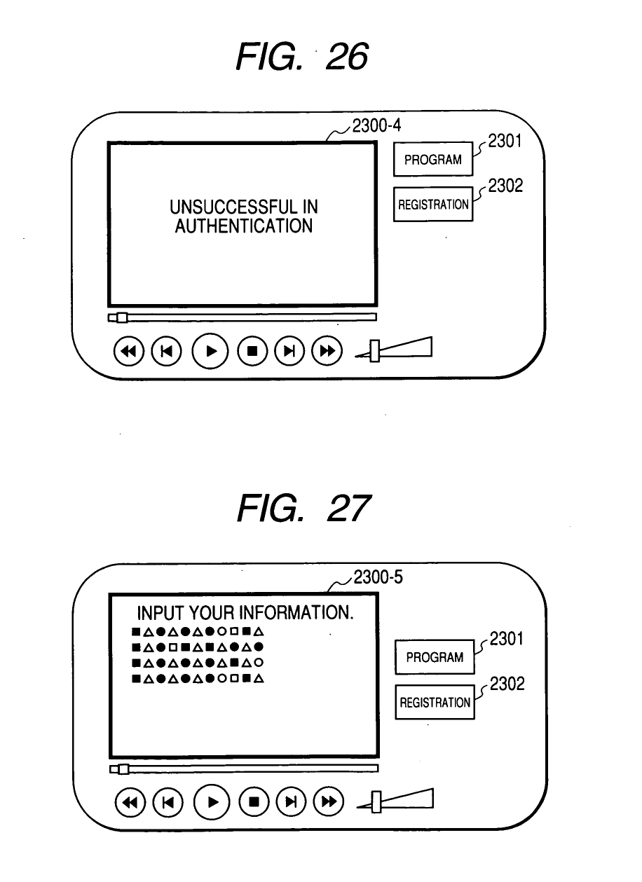

Upon receiving the authentication rejection from the authentication server 123, a processor 42 in a protocol processing unit 31 provided for the packet transfer apparatus 2 counts authentications and registers the number of authentications with the user administration table 47-1 (Step 2007). The sequence from Steps 2001 to 2007 is repeated until the number of authentication is 2. At the second authentication, the processor 42 then makes to a web server 124 a request for the provision to a terminal 121 of a screen 2300-4 (“Unsuccessful in authentication”) shown in FIG. 26 (Step 2008).

The web server 124 then transmits the screen 2300-4 to the terminal 121. This allows the screen 2300-4 to be displayed on the WWW browser of the terminal 121.

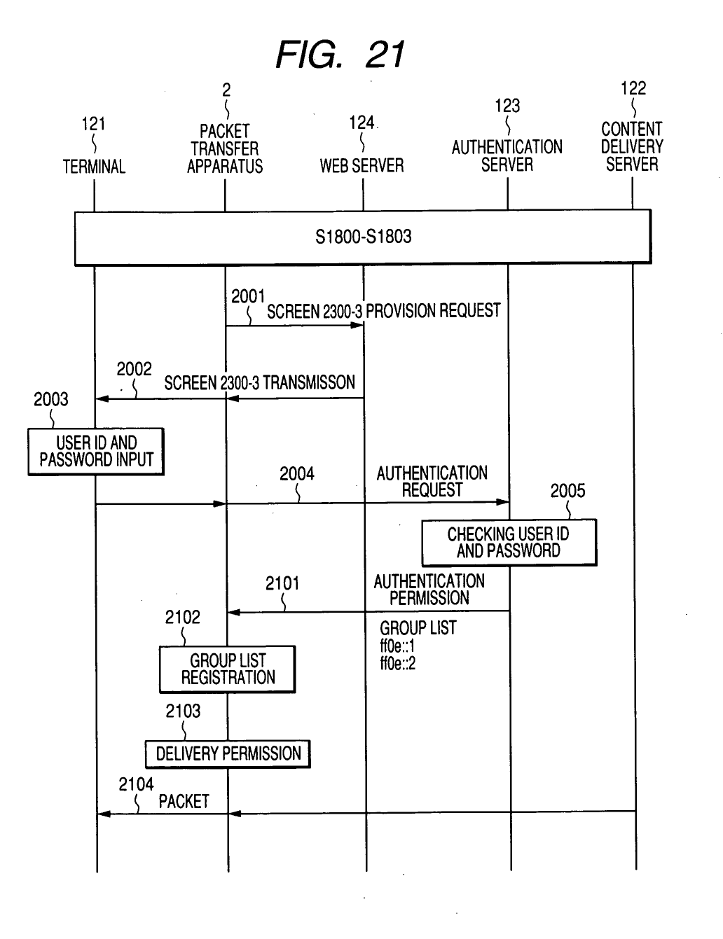

FIG. 21 is a sequence diagram showing the operation of the communications system 120 for authentication permission in IP multicast communications. Note that the sequence from Steps 1800 to 1803 and 2001 to 2005 is the same as in FIG. 20.

An authentication server 123 checks the user ID and the password for the terminal 121 with an user ID and a password registered with a group list administration table (Step 2005). If there are a relevant user ID and a relevant password in the table, the authentication server 123 transmits authentication permission and a group list (ff0e::1, ff0e::2) to the packet transfer apparatus 2 (Step 2101).

A processor 42 in a protocol processing unit 31 provided for the packet transfer apparatus 2 registers the group list of the terminal 121 received from the authentication server 123 with a user administration table 47-1 (Step 2102). The processor 42 also permits the delivery of a multicast packet from a content delivery server 122 (Step 2003) and transmits the multicast packet to the terminal 121 (Step 2104).

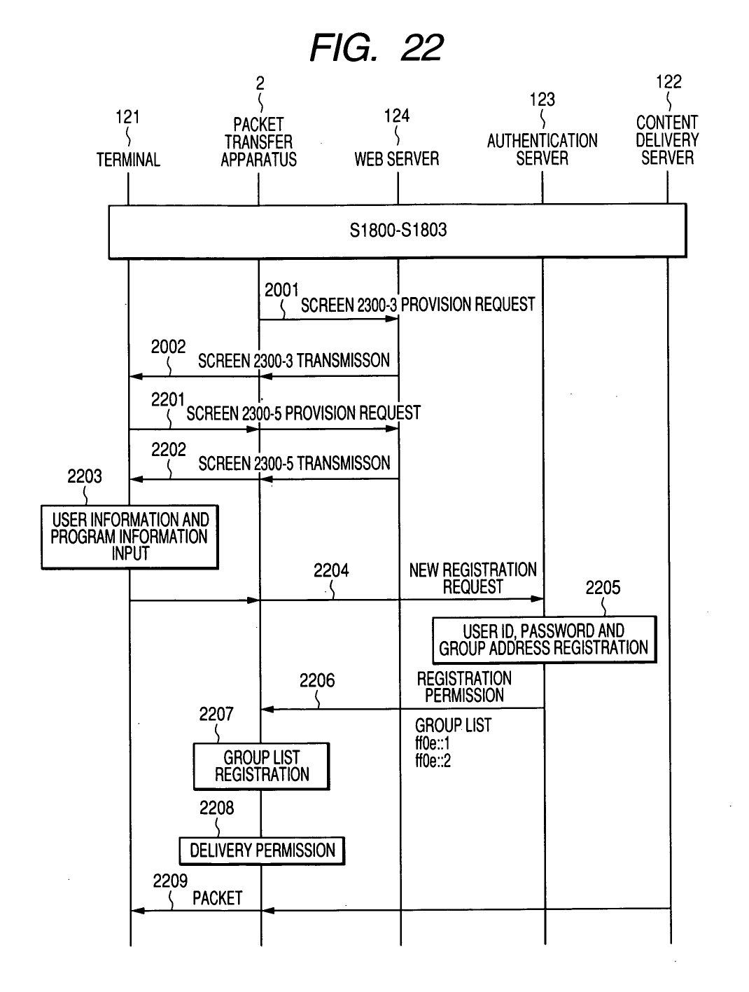

FIG. 22 is a sequence diagram showing the operation of the communications system 120 for the new registration of user information and a program viewed in IP multicast communications. Note that the sequence from Steps 1800 to 1804 and 2001 to 2002 in FIG. 22 is the same as in FIG. 20. However, it is now assumed that at Step 1804, new registration has been selected in a screen 2300-3 (“Register if you are new. Input your ID and a password if you have them.”) shown in FIG. 25.

From the terminal 121, a request for the provision of a screen 2300-5 (“Input your information”) shown in FIG. 27 is transmitted to the web server 124 via the packet transfer apparatus 2 (Step 2201).

The web server 124 transmits the screen 2300-5 to the terminal 121 (Step 2202) via the packet transfer apparatus 2 to prompt the terminal to new registration. This allows the screen 2300-5 to be displayed on the WWW browser of the terminal 121.

When the user of the terminal 121 inputs user information (including a user ID and a password) and information on a desired program (group address: ff0e::1, ff0e::2, for example) from the terminal 121 and presses a registration button 2302 (Step 2203), a request for new registration is transmitted to an authentication server 123 via the packet transfer apparatus 2 from the terminal 121 (Step 2204). Note that a desired program may be selected from a program 2301 when the program information is inputted.

Upon receiving the request for new registration from a terminal 121, an authentication server 123 newly registers the user ID, password and group address (ff0e::1, ff0e::2) of the terminal 121 contained in the request with a group list administration table (Step 2205). The authentication server 123 then transmits a registration permission and the group address (ff0e::1, ff0e::2) to the packet transfer apparatus 2 (Step 2206).

A processor 42 in a protocol processing unit 31 provided for the packet transfer apparatus 2 registers a group list from the authentication server 123 with a user administration table 47-1 (Step 2207). The processor 42 also permits the delivery of a multicast packet from a content delivery server 122 (Step 2208) and transmits the multicast packet to the terminal 121 (Step 2209).

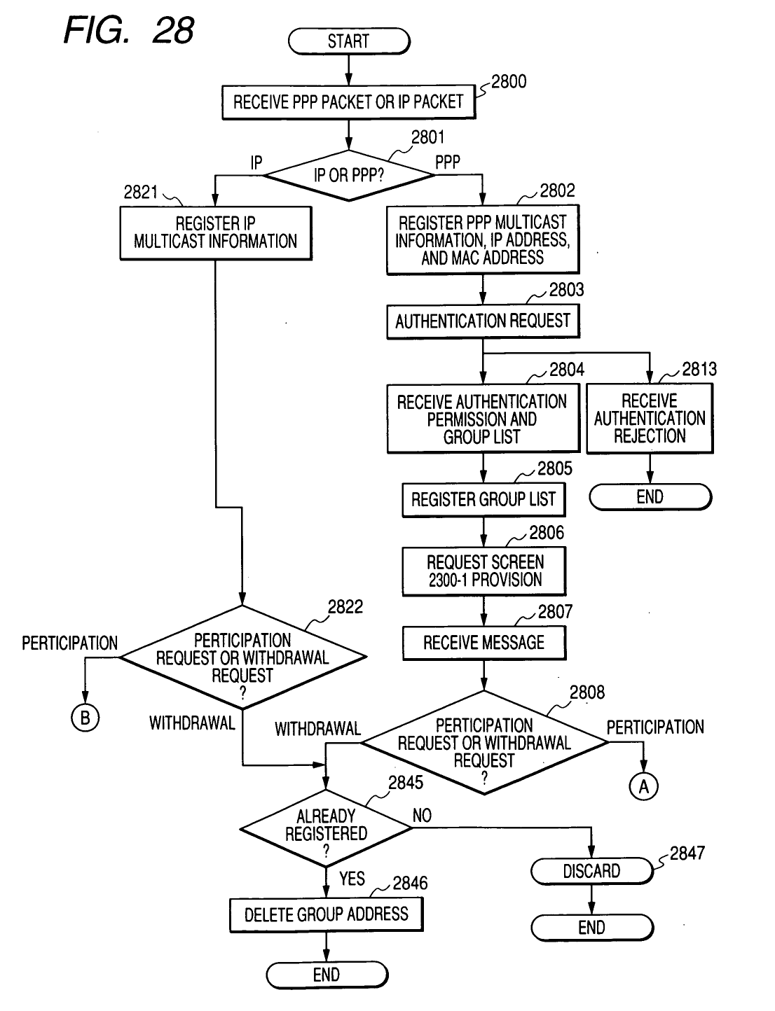

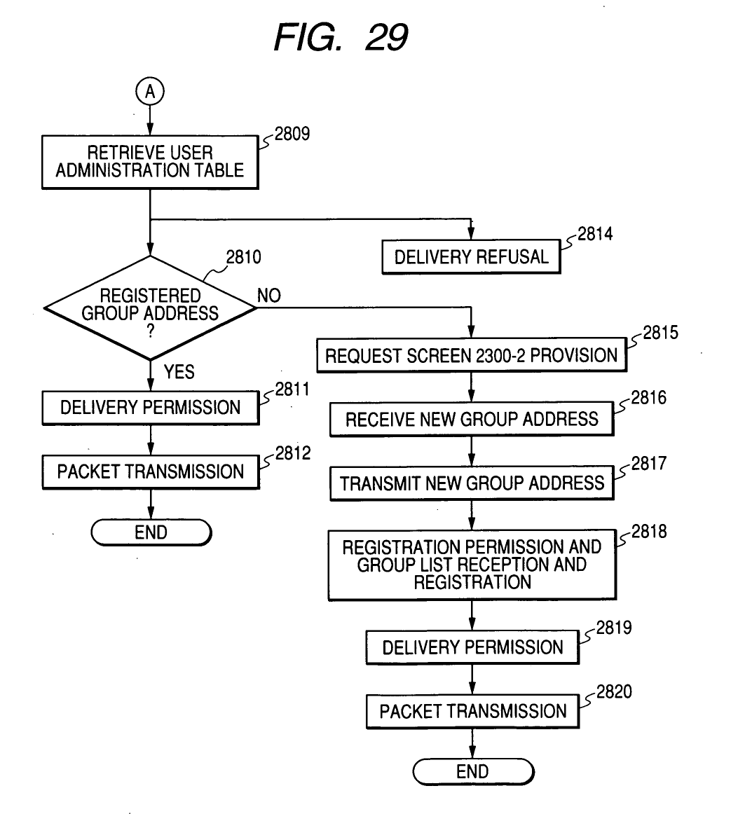

FIGS. 28 to 31 are flow charts showing processing by a processor 42 provided for the protocol processing unit 31 of the packet transfer apparatus 2 according to the second embodiment of the present invention.

Upon receiving a PPP packet or an IP packet from a terminal (Step 2800), the processor 42 first identifies IP or PPP multicast communications through the packet (Step 2801). PPP multicast communications involves a PPP header attached to the PPP packet and can be identified through the presence or absence of the PPP header. Note that the processor 42 determines the protocol (the IPv4 or IPv6) through a “version number” provided for the header of the IPv4 packet or the IPv6 packet contained in the PPP packet. If the type of the packet received is a PPP multicast packet at Step 2801, the processor 42 registers PPP multicast information, an IP address and an MAC address with a user administration table 47-1 (Step 2802). The processor 42 then makes an authentication to an authentication server 4. If authentication is permitted by the authentication server 4, the processor 42 receives an authentication permission and a relevant group list from the authentication server 4 (Step 2804). The processor 42 then associates the authentication permission and the relevant group list with information on a relevant terminal before registration with a user administration table 47-1 (Step 2805). The processor 42 then makes to a web server 100 a request for the provision of a screen 2300-1 shown in FIG. 23 (Step 2806). When, for example, receiving an IGMP message, the processor 42 determines whether the message is a participation request or a withdrawal request through the type 21 of the header 20 of the message (Step 2807). If the message is a participation request, the processor 42 registers the participation request with a user administration table 47-1 based on the IP address and the MAC address (Step 2809, FIG. 29). If a group address contained in the participation request is present in the group list as a result of the retrieval (Step 2810), the processor 42 permits the delivery of a multicast packet from a content delivery server 3 (Step 2811) and transmits the multicast packet to the terminal 1 (Step 2812).

As a result that the processor 42 makes a authentication request to the authentication server 4 at Step 2803, FIG. 28, if the authentication is rejected, the processor 42 receives the authentication rejection from the authentication server (Step 2813).

If a group address contained in the participation request is not present in the group list as a result of the retrieval at Step 2810, FIG. 29, the processor 42 makes to a web server 100 a request for the provision to the terminal of a screen 2300-2 shown in FIG. 24 (Step 2815). The processor 42 then receives a request for the registration of a new group address from the terminal (Step 2816) and forwards the request to the authentication server 4. Upon receiving registration permission and a terminal group list contained in the participation request from the authentication server 4, the processor 42 associates the registration permission and the terminal group list with information on the terminal before registration with the user administration table 47-1 (Step 2818). The processor 42 then permits the delivery of a multicast packet from a content delivery server 3 (Step 2819) and transmits the multicast packet to the terminal (Step 2820).

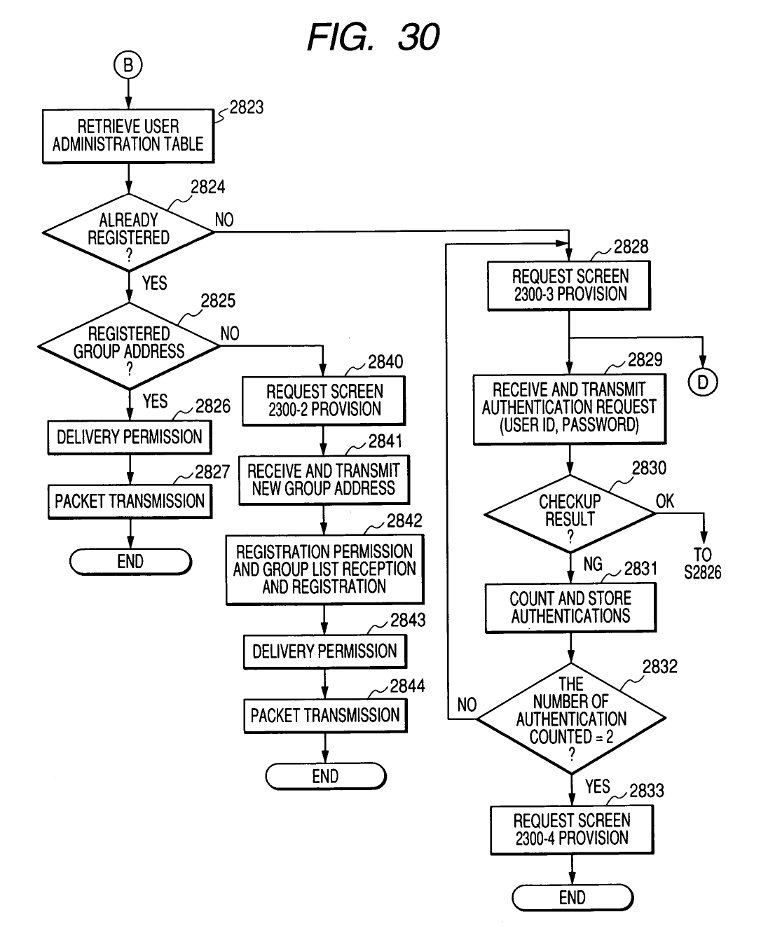

If the type of the packet received is an IP multicast packet at Step 2801, FIG. 28, the processor 42 registers IP multicast information with the user administration table 47-1 (Step 2821). The processor 42 then determines whether the message (e.g., an MLD message) contained in the packet is a participation request or a withdrawal request through the type 131 of the header 130 of the message (Step 2822). If the message is a participation request, the processor 42 retrieves the user administration table 47-1 based on the IP address contained in the participation request (Step 2823, FIG. 30). If the IP address is in the table as a result of the retrieval, the processor 42 retrieves the user administration table 47-1 based on the group address (Step 2824). If the group address is already registered with the user administration table 47-1, the processor 42 permits the delivery of a multicast packet from the content delivery server 3 (Step 2826) and transmits the multicast packet to the terminal 121 (Step 2827).

If the IP address is not in the table as a result of the retrieval at Step 2824, the processor 42 makes to a web server 124 a request for the provision to the terminal of a screen 2300-3 shown in FIG. 25 (Step 2828). Upon receiving a checkup result (authentication rejection) from an authentication server 123 (Step 2830), the processor 42 counts authentications and registers the number of authentications with the user administration table 47-1 (Step 2831). If the number of authentications counted is not two, the processor 42 returns to Step 2828. If the number of authentications counted is two at Step 2832, the processor makes to the web server 124 a request for the provision to a terminal 121 of a screen 2300-4 shown in FIG. 26 (Step 2833).

When the processor receives a checkup result (an authentication permission and a group list) at Step 2830, the group list is registered with the user administration table 47-1 and the processor performs the processing for Steps 2826 and 2827.

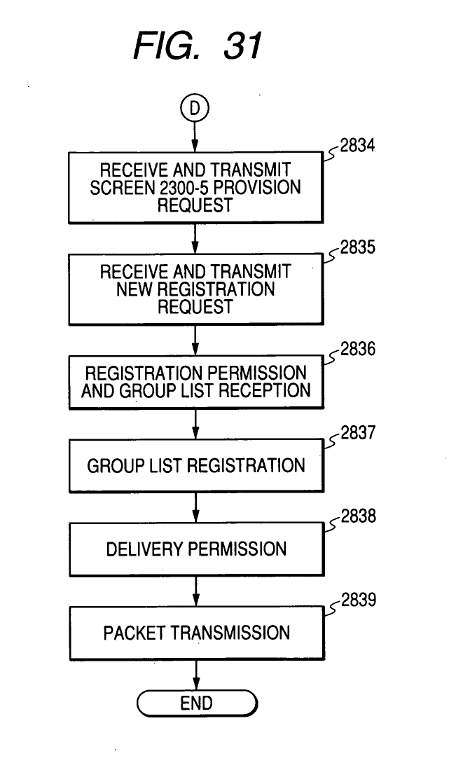

Upon receiving a request for the provision of the screen 2300-5 from the terminal 121 after the processing for Step 2828, the processor forwards the provision request to the web server 124 (Step 2834, FIG. 31). Upon receiving a request for new registration from the terminal 121, the processor 42 then forwards the new-registration request to the authentication server 123 (Step 2835). The processor 42 then receives registration permission and a group list from the authentication server 123 (Step 2836) and registers the received group list with the user administration table 47-1 (Step 2837). The processor 42 also permits the delivery of a multicast packet from a content delivery server 122 (Step 2838) and transmits the multicast packet to the terminal 121 (Step 2839).

If the type of a message is a withdrawal request at Step 2808 or 2822, FIG. 28, the processor determines whether the group address contained in the withdrawal request is already registered with a group list in the user administration table 47-1 (Step 2845). If so, the processor deletes the group address from the group list (Step 2846). If not so, the processor discards the multicast packet that otherwise would be transmitted from the content delivery server to the terminal (Step 2847).

Upon receiving a packet from any of a plurality of terminals, as described above, according to the second embodiment, the processor identifies PPP multicast communications or IP multicast communications from the packet and performs processing for each of these two types of communications, thus allowing packet transfer. This makes it possible to accommodate both of PPP multicast communications and IP multicast communications.

Note that in the second embodiment, the web servers 100 and 124 are designed to transmit information for prompting a user to the registration of a non-contracted program and a new registration of user information to user terminals 1 and 121. If, however, a function of prompting a user to these registrations is not required, web servers 100 and 124 may not be provided. If the packet transfer apparatus 2 receives a request for participation in a non-contracted program from the terminal 1 or 121 in this case, the apparatus rejects the delivery of the request because there is not a group address already registered at Step 2810 (FIG. 29).

What is claimed is:

1. A packet transfer apparatus including a plurality of terminals and adapted to transfer a packet between said plurality of terminals and a network; said apparatus comprising:
a plurality of line interfaces adapted to receive and transmit said packet from and to said plurality of terminals or said network; and
a processing unit for performing necessary processing based on contents of a packet received through any of said plurality of line interfaces before output to any of the plurality of line interfaces;
wherein said processing unit performs the steps of:
upon receiving a connection request from one of the plurality of terminals, storing information on said terminal in a memory;
forwarding information necessary for authenticating said terminal and an authentication request to a authentication server in the network;
receiving authentication permission from the authentication server and a group address list associated with said terminal that has made the connection request;
associating said multicast group address list received with the information on said terminal stored in said memory for registration; and
upon receiving a participation request from one of said plurality of terminals, determining whether or not a multicast group address contained in said participation request is present in the list in said memory, and permitting packet delivery from said network to said terminal if the multicast group address is present in the list in the memory, while rejecting the packet delivery from said network to said terminal if said multicast group address is not present in the list in the memory.

2. The packet transfer apparatus according to claim 1, wherein upon receiving a withdrawal request from one of the plurality of terminals, said processing unit determines whether or not an multicast group address contained in said withdrawal request is present in the list in said memory, and deletes said multicast group address from the list in said memory if said multicast group address is present in the list in said memory, while discarding a packet from said network if said multicast group address is not present in the list in said memory.

3. The packet transfer apparatus according to claim 1, wherein said information necessary for authentication includes an ID and a password for the terminal that has made the connection request.

4. The packet transfer apparatus according to claim 2, wherein said information necessary for authentication includes an ID and a password for the terminal that has made the connection request.

5. The packet transfer apparatus according to claim 1, wherein said network is a network using an internet protocol.

6. The packet transfer apparatus according to claim 2, wherein said network is a network using an internet protocol.

7. The packet transfer apparatus according to claim 3, wherein said network is a network using an internet protocol.

8. The packet transfer apparatus according to claim 4, wherein said network is a network using an internet protocol.

9. A packet transfer apparatus including a plurality of terminals and adapted to transfer a multicast packet between said plurality of terminals and a network; said apparatus comprising:
a plurality of line interfaces adapted to receive and transmit said packet from and to said plurality of terminals or said network; and
a processing unit for performing necessary processing based on contents of a packet received through any of said plurality of line interfaces before outputs to any of the plurality of line interfaces;
wherein said processing unit performs the steps of:
upon receiving a packet from one of said plurality of terminals, identifying a multicast type from said packet and, if the multicast type is a PPP multicast type, storing information on said terminal in a memory;
forwarding a packet for an authentication request for said terminal to said network;
receiving authentication permission from said network and a multicast group address list associated with said terminal;
associating said multicast group address list received with the information on said terminal stored in said memory for registration; and
upon receiving a participation request from said terminal, permitting or refusing a delivery of the multicast packet received from said network to said terminal based on contents of said packet and contents of said memory.

10. The packet transfer apparatus according to claim 8, wherein if the multicast type of the packet received is an IP multicast type, said processing unit determines whether or not said terminal information and multicast address are registered with said memory, and
if said terminal information and multicast address are registered with said memory, said processing unit transmits the multicast packet received from said network to said terminal.

11. The packet transfer apparatus according to claim 8, wherein said processing unit performs the steps of:
upon receiving a withdrawal request from one of the plurality of terminals, determining whether or not an multicast group address contained in said withdrawal request is present in the list in said memory;
deleting said multicast group address from the list in said memory if said multicast group address is present in the list in said memory; and
discarding the packet from said network if said multicast group address is not present in the list in said memory.
